(19) United States
(12) Patent Application Publication
(10) Pub. No.: US 2024/0052090 A1
(43) Pub. Date: Feb. 15, 2024

(54) A TWO-COMPONENT POLYURETHANE COMPOSITION, PROCESS FOR PREPARING THE SAME AND A METHOD OF USE THEREOF

(71) Applicant: ASHLAND LICENSING AND INTELLECTUAL PROPERTY LLC, DUBLIN, OH (US)

(72) Inventors: Jiqiang XIA, Dublin, OH (US); Lucia Blanco LOARTE, Worcestershire (GB)

(21) Appl. No.: 18/267,118

(22) PCT Filed: Dec. 16, 2021
(86) PCT No.: PCT/US2021/063701

§ 371 Date: Jun. 14, 2023

Related U.S. Application Data
(60) Provisional application No. 63/126,587, filed on Dec. 17, 2020.

(51) Int. Cl. C08G 18/76; C08G 18/42; C08G 18/32; C08G 18/48; C08G 18/10; C08G 18/18; C08G 18/16; C08K 9/04; C08K 3/34; C08K 3/36

(52) U.S. Cl. CPC C08G 18/7664; C08G 18/4277; C08G 18/4202; C08G 18/3234; C08G 18/4825; C08G 18/10; C08G 18/4829; C08G 18/4841; C08G 18/3206; C08G 18/4816; C08G 18/1808; C08G 18/165; C08K 9/04; C08K 3/346; C08K 3/36

(57) ABSTRACT

This present disclosure relates to a two-component polyurethane composition comprising: (A) a prepolymer component comprising: (i) at least one isocyanate terminated intermediate compound prepared from a reaction mixture comprising at least one isocyanate compound and at least one active hydrogen containing compound selected from the group consisting of a polyol compound, a polyamine compound and a combination thereof, (ii) at least one isocyanate compound, and (iii) optionally at least one liquid rubber; and (B) a curative component comprising: (i) at least one polyol terminated intermediate compound prepared from a reaction mixture comprising at least one isocyanate compound and at least one active hydrogen containing compound selected from the group consisting of a polyol compound, a polyamine compound and a combination thereof, (ii) at least one liquid rubber, (iii) at least one catalyst, (iv) at least one polyol, (v) optionally at least one amine compound, and (vi) optionally a chain extender.

### FIELD OF THE INVENTION

The presently disclosed process(es), procedure(s), method(s), product(s), result(s), and/or concept(s) (collectively referred to hereinafter as the “present disclosure or invention”) relates generally to a two-component polyurethane composition, a process for preparing the same and a method of use thereof.

### BACKGROUND OF THE INVENTION

Adhesives are used for bonding a wide variety of similar and dissimilar metallic as well as non-metallic materials, composites and components with different shapes, sizes and thicknesses. The advantages of adhesive bonding over traditional joining techniques (mechanical fastening) is well appreciated. In particular, adhesives give greater design flexibility, distribute of load over a much greater area, minimizes stress concentrations, and enhance fatigue resistance and corrosion resistance of bonded joints. In addition, adhesives provide less weight to the whole structure, enhancing the appearance of the bond while joining different materials. High-performance structural adhesives have become common in the aerospace, automotive, marine, medical science, and/or construction sectors. Advanced structural adhesives are not only being applied as a joining method but also in manufacturing of composite materials such as. Glare, a specific type of fiber-metal laminate made from aluminium and fiberglass composite. The joining components can be thermoplastics, thermostable polymer, sheet molding compound (commonly referred to as SMC), glass and/or metals.

Globally, the compression molding of sheet molding compound (SMC) is the third most intensively used technique for the production of polymer composite parts worldwide (behind the injection of reinforced thermoplastics and the hand lay-up techniques). The automotive and truck industries remain the drivers of the SMC technology, but SMC are commonly used in the agricultural, rail and marine (interior and body parts, watercraft parts, etc.), electrical (low voltage and medium voltage energy systems, fuses and switchgear, cabinets and junction boxes, encapsulation of wirings and electronic circuits, electrical components with reduced surface resistivity, lamp housings) and energy (parts for wind turbine and solar power applications, etc.), sanitary (sinks and bath tubs, toilet seats, drain covers, etc.), domestic appliance (blower housings, drain pans, and heating, ventilation, and air conditioning (HVAC) systems, vent trims, parabolic mirrors, swimming pool panels, etc.), building and construction (drinking water tanks, panels, doors, etc.), and medical (surgery equipment, dental medication systems, antibacterial components, Biomedical equipment) sectors. Also, the use of rigid fiber-reinforced plastic composite materials in the form of sheet molding compounds as an alternative for steel automotive body panels is increasing in an effort to reduce weight and corrosion susceptibility.

The demands of modern industries such as those of the automotive, aeronautic and shipbuilding sectors, where there is a strong commitment to increasing productivity, with requirements for high quality indices, have lead to an ever increasing use of structural adhesives on their assembly lines. The advantages offered by structural adhesives in relation to traditional mechanical joints, such as welds, rivets or screws, include the possibility to bond distinct materials with different thermal expansion coefficients, obtaining monolithic structures which are mechanically extremely resistant. It is also possible to achieve a reduction in weight, greater stiffness and better surface finish than bonds formed by mechanical fixing.

The bonding of parts using structural adhesives offers significant benefits in relation to traditional systems. The adhesive distributes the loads and stresses acting on the total bond area instead of concentrating them, allowing not only a uniform distribution of static and dynamic loads but also reducing the production and maintenance costs in relation to mechanically fixed systems. Industrially, in many cases the methods of adhesive application offer higher productivity in the assembly processes. Another important advantage resulting from an effective adhesion is a good seal between the bonded parts, inhibiting the passage of fluids through the joint and dispensing with the need for additional impermeabilization.

The adhesive joint design must be selected considering the nature of its future application. Silva et al. (International Journal of Adhesion and Adhesives. 2007; 27:362-379) performed a study to evaluate joints (composites, aluminum and titanium) designed with epoxy and bismaleimide adhesives at different temperatures. The authors evaluated the distribution of stresses along the joints by way of finite elements analysis.

Malucellia et al. (International Journal of Adhesion and Adhesives. 2005; 25:87-91) disclosed shear strength of joints bonded with a monocomponent polyurethane adhesive (base polyester) on substrates of polyoxypropylene, polypropylene and aluminum. Also, the authors investigated surface treatment methods, kinetics reaction and the thermal behavior of the adhesive and obtained as a result an increase in shear strength after treatment and the speed of the adhesive cure reaction by varying the air humidity and the parameters of the temperature of use.

Liquid rubbers are normally used to improve properties such as abrasion, processability and dynamic properties within the rubber industry.

Chinese application No. 105111996 relates to a two-component flexible colorful polythiourethane-polysulfone sealant containing polysulfone type liquid rubber, plasticizer, filler, tackifier, antioxidant, vulcanizing agent, plasticizer, colorant and filler.

Japanese application JP-A-4309588 relates to an adhesive composition comprising block copolymer, liquid polymer and isocyanate.

European patent 670,864 relates to a pressure sensitive adhesive composition comprising a solid rubber and a liquid rubber.

Accordingly, there is a need in the 2K (two-component) polyurethane and thermoset polyurethanes industry for a structural adhesive with improved adhesion and functionality.

Thus, the present disclosure reveals that unreactive liquid rubbers blended with 2K polyurethane adhesive formulations unexpectedly provide improved adhesion and functionality.

### SUMMARY OF THE INVENTION

These and other objects of the present disclosure will become apparent in light of the following disclosure.

One objective of the present disclosure relates to a two-component polyurethane composition exhibiting improved adhesion and functionality comprising: (A) a prepolymer component comprising: (i) at least one isocyanate terminated intermediate compound prepared from a reaction mixture comprising at least one isocyanate compound and at least one active hydrogen containing compound selected from the group consisting of a polyol compound, a polyamine compound and a combination thereof, (ii) at least one isocyanate compound, and (iii) optionally at least one liquid rubber; and (B) a curative component comprising: (i) at least one polyol terminated intermediate compound prepared from a reaction mixture comprising at least one isocyanate compound and at least one active hydrogen containing compound selected from the group consisting of a polyol compound, a polyamine compound and a combination thereof, (ii) at least one liquid rubber, (iii) at least one catalyst, (iv) at least one polyol, (v) optionally at least one amine compound, and (vi) optionally a chain extender.

Another objective of the present disclosure relates to a two-component polyurethane composition comprising: (A) a prepolymer component comprising: (i) at least one isocyanate terminated intermediate compound prepared from a reaction mixture comprising at least one isocyanate compound and at least one active hydrogen containing compound selected from the group consisting of a polyol compound, a polyamine compound and a combination thereof, (ii) at least one isocyanate compound, and (iii) optionally at least one liquid rubber; and (B) a curative component comprising: (i) at least one polyol terminated intermediate compound prepared from a reaction mixture comprising at least one isocyanate compound and at least one active hydrogen containing compound selected from the group consisting of a polyol compound, a polyamine compound and a combination thereof, (ii) at least one liquid rubber, (iii) at least one catalyst, (iv) at least one polyol, (v) optionally at least one amine compound, and (vi) optionally a chain extender; wherein the polyamine compound is selected from the group consisting of primary amine-terminated poly(oxypropylene), primary amine-terminated poly(oxyethylene), secondary amine-terminated poly(oxypropylene), secondary amine-terminated poly(oxyethylene) and amino functional polysiloxane.

Another objective of the present disclosure relates to a two-component polyurethane composition comprising: (A) a prepolymer component comprising: (i) at least one isocyanate terminated intermediate compound prepared from a reaction mixture comprising at least one isocyanate compound and at least one active hydrogen containing compound selected from the group consisting of a polyol compound, a polyamine compound and a combination thereof, (ii) at least one isocyanate compound, and (iii) optionally at least one liquid rubber; and (B) a curative component comprising: (i) at least one polyol terminated inter mediate compound prepared from a reaction mixture comprising at least one isocyanate compound and at least one active hydrogen containing compound selected from the group consisting of a polyol compound, a polyamine compound and a combination thereof, (ii) at least one liquid rubber, (iii) at least one catalyst, (iv) at least one polyol, (v) optionally at least one amine compound, and (vi) optionally a chain extender; wherein the polyol is selected from the group consisting of polyether polyol, polyester polyol, polycarbonate polyol, ethylene oxide end-capped polyol, polybutadiene polyol, polyacetal polyol, and a combination thereof.

### BRIEF DESCRIPTION OF THE DRAWINGS

FIG. 1 depicts adhesive bonding with the compositions prepared according to Example 1 with a substrate composite polyamide reinforced with glass fiber

FIG. 2 depicts adhesive bonding with the compositions prepared according to Example 2 with a substrate composite polyamide reinforced with glass fiber

FIGS. 3(a), 3(b), and 3(c) depict adhesive bonding with the compositions prepared according to Example 3 with a substrate (a) Aluminium (Aluminium type EN AW 6063 T6)+epoxy primer on top, (b) Glass+Primer on top, and (c) Aluminium (5005A (AlMgI) Tin passivated) with epoxy primer on the top respectively

FIGS. 4(a), 4(b) and 4(c) depict adhesive bonding with the compositions prepared according to Example 4 with a substrate (a) Aluminium (5005A (AlMgI) Tin passivated) and epoxy primer, (b) Aluminium (Aluminium type EN AW 6063 T6), and (c) Aluminum (Aluminium type EN AW 5754 H22) respectively

It should be noted that the figures are diagrammatic and not drawn to scale. Relative dimensions and proportions of parts of these figures have been shown exaggerated or reduced in size, for the sake of clarity and convenience in the drawings.

### DETAILED DESCRIPTION OF THE INVENTION

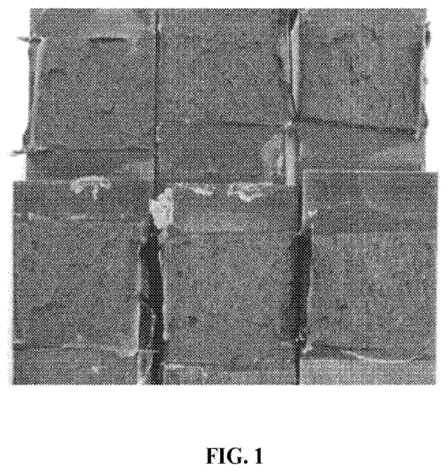

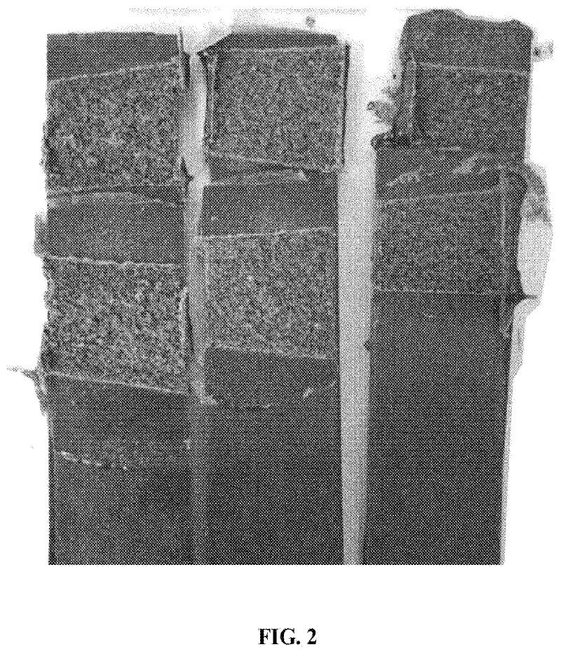

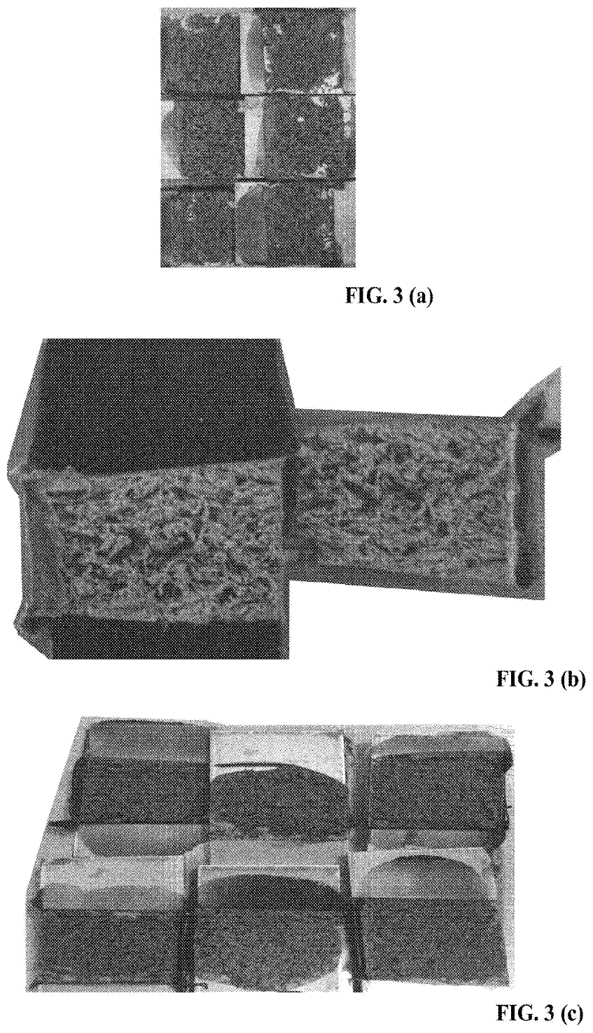

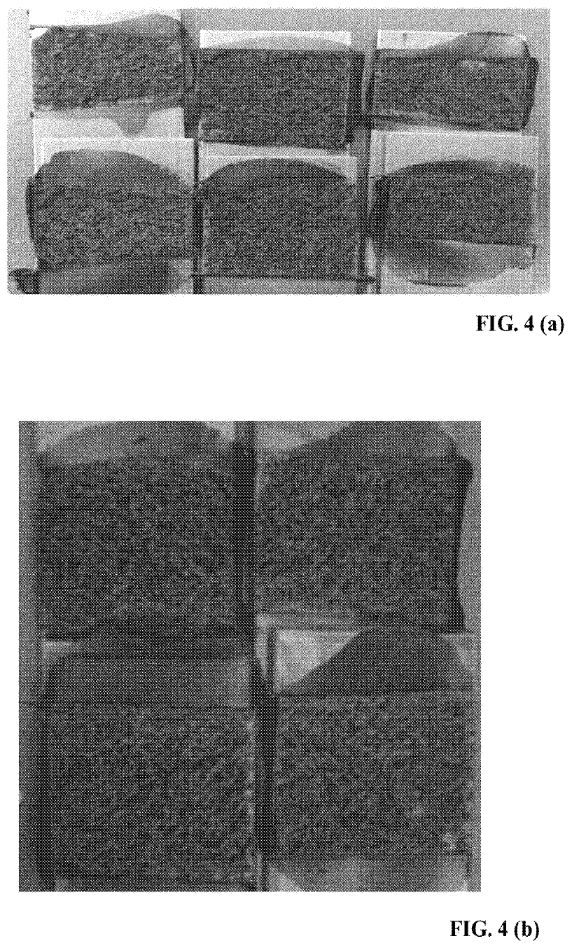

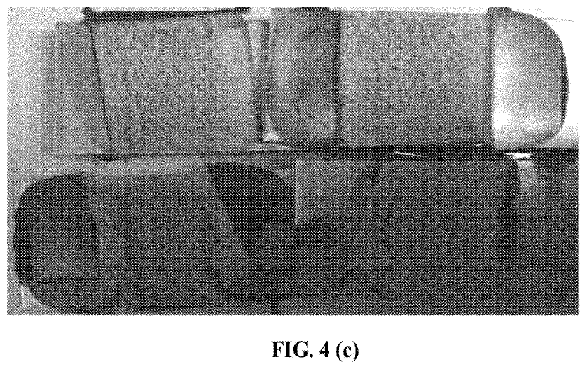

An exemplary embodiment of the present disclosure will now be described with reference to the FIGS. 1-4 (c).

Before explaining at least one embodiment of the present disclosure in detail, it is to be understood that the present disclosure is not limited in its application to the details of construction and the arrangement of the components or steps or methodologies set forth in the following description or illustrated in the drawings. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the present disclosure have been described in terms of preferred embodiments, it will be apparent to those of ordinary skill in the art that variations can be applied to the articles and/or methods and in the steps or in the sequence of steps of the method(s) described herein without departing from the concept, spirit and scope of the present disclosure. All such similar substitutes and modifications apparent to those skilled in the art are deemed to be within the spirit, scope and concept of the present disclosure.

As utilized in accordance with the present disclosure, the following terms, unless otherwise indicated, shall be understood to have the following meanings.

The use of the word “a” or “an” when used in conjunction with the term “comprising” can mean “one.” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.” Throughout this application, the term “about” is used to indicate that a value includes the inherent variation of error for the quantifying device, the method(s) being employed to determine the value, or the variation that exists among the study subjects.

References herein to “one embodiment,” or “one aspect” or “one version” or “one objective” or “another embodiment,” or “another aspect” or “another version” or “another objective” of the present disclosure can include one or more of such embodiment, aspect, version or objective, unless the context clearly dictates otherwise.

The term “at least one” refers to one as well as any quantity more than one, including but not limited to, 1, 2, 3, 4, 5, 10, 15, 20, 30, 40, 50, 100, etc. The term “at least one” can extend up to 100 or 1000 or more depending on the term to which it is attached.

All percentages, parts, proportions, and ratios as used herein are by weight of the total composition, unless otherwise specified. All such weights as they pertain to listed ingredients are based on the active level and therefore do not include solvents or by-products that can be included in commercially available materials, unless otherwise specified.

All references to singular characteristics or limitations of the present disclosure shall include the corresponding plural characteristics or limitations, and vice-versa, unless otherwise specified or clearly implied to the contrary by the context in which the reference is made.

Numerical ranges as used herein are intended to include every number and subset of numbers contained within that range, whether specifically disclosed or not. Further, these numerical ranges should be construed as providing support for a claim directed to any number or subset of numbers in that range.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The terms “or combinations thereof” and “and/or combinations thereof” as used herein refer to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more items or terms, such as BB, AAA, AAB, BBC, AAABCCCC, CBBAAA, CABABB, and so forth. The skilled artisan will understand that typically there is no limit on the number of items or terms in any combination, unless otherwise apparent from the context.

For purposes of the following detailed description, other than in any operating examples, or where otherwise indicated, numbers that express, for example, quantities of ingredients used in the specification and claims are to be understood as being, modified in all instances by the term “about”. The numerical parameters set forth in the specification and attached claims are approximations that can vary depending upon the desired properties to be obtained in carrying out the invention.

The term “or combinations thereof”, and combinations thereof and “combinations thereof” as used herein refers to all permutations and combinations of the listed items preceding the term.

The term “about” refers to a range of values+10% of a specified value. For example, the phrase “about 200” includes +10% of 200, or from 180 to 220.

The term “polymerization” or “polymerizing” refers to methods for chemically reacting monomer compounds to form polymer chains. The polymer chain can be alternating, blocked, or random. The type of polymerization method can be selected from a wide variety of methods and include the following non-limiting examples: poly condensation, step growth polymerization, and free radical polymerization.

The term “polymer” refers to any large molecule, which includes macromolecules. The term “polymer” refers to a large molecule comprising one or more types of monomer residues (repeating units) connected by covalent chemical bonds. Non-limiting examples of polymers include homopolymers, and non-homopolymers such as copolymers, terpolymers, tetrapolymers and the higher analogues.

The term “monomer” refers to a small molecule that chemically bonds during polymerization to one or more monomers of the same or different kind to form in a polymer.

The term “ambient temperature”, as used herein, refers to the temperature encountered both indoors and out, which during the course of the various seasons can run from below −20° C. to over 40° C. The rate of cure will be slower at the lower temperature and accelerated at the higher ones. Although there is no lower limitation on temperature, ordinarily the compositions of the present invention will not be applied at temperatures below about 5° C. The higher temperatures encountered may reach over 40° C. in the summer, and surface temperatures of black surfaces such as roofs or asphalt may run up to 65° C. or higher. The important factor is that external heat need not be applied to cause the cure, thus permitting the present invention to be of greatly extended utility.

The term “liquid rubber” of this invention include vulcanised electromeric network with a molecular weight and crosslinked balance appropriate to be “liquid” in terms of easy pourable at ambient temperatures. The liquid rubber needs to have a transition temperature below the ambient temperatures. The liquid rubber can carry reactive groups at the end of the chains, but these groups cannot be reactive with other components of the mixture with the prepolymer part and curative part of the current invention, therefore the liquid rubber acts as a plasticizer and its not part of the final polymer or crosslinked product. The liquid rubbers useful in the practice of the present invention include, but are not limited to, synthetic liquid isoprene rubber, depolymerized natural rubber, carboxyl terminated synthetic liquid isoprene styrene rubber, hydroxyl terminated synthetic liquid isoprene rubber, hydrogenated liquid isoprene rubber, liquid isoprene-styrene copolymer, and liquid isoprene-butadiene liquid butadiene-styrene copolymer. The liquid rubbers typically have a molecular weight of 25,000 to 50,000. Preferably, the liquid rubbers have a glass transition temperature of less than −50° C., on a melt viscosity at 38° C. of between 50-1,000 Pas (500-10,000 poises). It will be appreciated that other liquid rubbers known in the art could be useful within the scope of the teachings of the present invention.

As used herein and the claims, the term “aliphatic and cycloaliphatic diisocyanates” refers to 6 to 100 carbon atoms linked in a straight chain or cyclized having two diisocyanate reactive end groups. In a non-limiting embodiment of the present invention, the aliphatic and cycloaliphatic diisocyanates for use in the present invention can include TMXDI and compounds of the formula R—(NCO)2 wherein R represents an aliphatic group or a cycloaliphatic group.

Suitable polyols for use in the present invention can include but are not limited to polyether polyols, polyester polyols, polycaprolactone polyols, polycarbonate polyols, and mixtures thereof.

Polyether polyols and methods for their preparation are known to those skilled in the art. Many polyether polyols of various types and molecular weight are commercially available from various manufacturers. Non-limiting examples of polyether polyols can include, but are not limited to, polyoxyalkylene polyols, and polyalkoxylated polyols. Polyoxyalkylene polyols can be prepared in accordance with known methods. In a non-limiting embodiment, a polyoxyalkylene polyol can be prepared by condensing an alkylene oxide, or a mixture of alkylene oxides, using acid- or base-catalyzed addition with a polyhydric initiator or a mixture of polyhydric initiators, such as but not limited to ethylene glycol, propylene glycol, glycerol, and sorbitol. Non-limiting examples of alkylene oxides can include ethylene oxide, propylene oxide, butylene oxide, amylene oxide, aralkylene oxides, such as but not limited to styrene oxide, mixtures of ethylene oxide and propylene oxide. In a further non-limiting embodiment, polyoxyalkylene polyols can be prepared with mixtures of alkylene oxide using random or step-wise oxyalkylation. Non-limiting examples of such polyoxyalkylene polyols include polyoxyethylene, such as but not limited to polyethylene glycol, polyoxypropylene, such as but not limited to polypropylene glycol.

The generic term “polyurethane” (PU), which is commonly used in the art, includes polyureas, polyisocyanurates and other polymers that may actually contain a small or zero number of urethane groups or bonds. As used herein, the term “polyurethane” is used more literally to refer to polymers that are reaction products of isocyanates and alcohols and thus contain significant amounts of urethane bonds, i.e., —NR—CO—O—. In the description and claims of the present invention, the term “polyurea” is used to refer to polymers that are interactions of isocyanates with each other in the presence of moisture or water, or interactions of isocyanates with amines, which may be intermediate reaction products, resulting in significant amounts of urea bonds, i.e., —NR′—CO—NR″—. In these urethane or urea bonds, each of R, R′, and R″ independently represent a hydrogen atom, an alkyl or aryl group. The term “polyurea” includes biurets that are formed when the urea group interacts with an additional isocyanate to form a branched polymer.

The term “polymer” should be understood as including polymers, copolymers (for example, polymers obtained using two or more different monomers), oligomers and combinations thereof, as well as polymers, oligomers or copolymers, which can be obtained in the form of a miscible composition.

The term “prepolymer” means a monomer or system of monomers that have reacted to form a state with an intermediate molecular weight. This material can additionally polymerize due to reactive groups, forming a fully cured high molecular weight state. As such, mixtures of reactive polymers with unreacted monomers may also be referred to as “prepolymers”. Typically, such prepolymers are polymers with a relatively low molecular weight, which is usually between the mass of the monomer and the film polymer or resin. As such, one of ordinary skill in the art can expect monomers to interact to form polyurea urea urethane, with the result that the monomer is no longer present once the polymer is formed. However, in some compositions described herein, both the monomer and the polymer may be present in the composition before it is cured, and after curing, the residual monomer may still be present in the cured polymer. Further, isocyanate-terminated prepolymer (preferably a polyether) can have amino-terminated or hydroxyl-terminated polyol and polyamine or polyol as a chain extension.

The term “polyamine” is used to refer to compounds containing at least two (primary and/or secondary) functional amino groups per molecule.

The term “polyol” is used to refer to compounds containing at least two hydroxyl functional groups per molecule. The term “diol” is used to refer to compounds containing two hydroxyl functional groups per molecule. The term “triol” is used to refer to compounds containing three hydroxyl functional groups per molecule.

As used herein, the term “isocyanate” is meant to refer to any chemical compound or molecule that includes one or more isocyanate (NCO) groups.

The term “polyisocyanate” is used to refer to compounds containing at least two isocyanate (NCO) functional groups per molecule.

The term “diisocyanate” is used to refer to compounds containing two isocyanate functional groups per molecule.

The present disclosure relates to a two-component polyurethane composition comprising: (A) a prepolymer component comprising: (i) at least one isocyanate terminated intermediate compound prepared from a reaction mixture comprising at least one isocyanate compound and at least one active hydrogen containing, compound selected from the group consisting of a polyol compound, a polyamine compound and a combination thereof, (ii) at least one isocyanate compound, and (iii) optionally at least one liquid rubber; and (B) a curative component comprising: (i) at least one polyol terminated intermediate compound prepared from a reaction mixture comprising at least one isocyanate compound and at least one active hydrogen containing compound selected from the group consisting of a polyol compound, a polyamine compound and a combination thereof, (ii) at least one liquid rubber, (iii) at least one catalyst, (iv) at least one polyol, (v) optionally at least one amine compound_ and (vi) optionally a chain extender.

In one non-limiting embodiment, the ratio of prepolymer component to curative component is from about 0.1 to about 1.

According to one more non-limiting embodiment, the range of the ratio of prepolymer component to curative component would include, but is not limited to, from about 0.1 to about 0.20, from about 0.21 to about 0.30, from about 0.31 to about 0.40, from about 0.41 to about 0.50, from about 0.51 to about 0.60, from about 0.61 to about 0.70, from about 0.71 to about 0.80, from about 0.81 to about 0.90 and from about 0.91 to about 1.0.

According to one more embodiment of the present disclosure, at least one isocyanate terminated intermediate compound is prepared from a reaction mixture comprising at least one isocyanate compound and at least one active hydrogen containing compound selected from the group consisting of a polyol compound, a polyamine compound and a combination thereof, wherein the reaction mixture has a ratio of isocyanate compound to polyol compound is greater than 2.

According to another embodiment of the present disclosure, at least one polyol terminated intermediate compound is prepared from a reaction mixture comprising at least one isocyanate compound and at least one active hydrogen containing compound selected from the group consisting of a polyol compound, a polyamine compound and a combination thereof, wherein the reaction mixture has a ratio of isocyanate compound to polyol compound less than 2.

According to one more embodiment of the present disclosure, at least one isocyanate terminated intermediate compound is prepared from a reaction mixture comprising at least one isocyanate compound and at least one active hydrogen containing compound selected from the group consisting of a polyol compound, a polyamine compound and a combination thereof, wherein the isocyanate terminated intermediate compound is present in an amount from about 10% w/w to about 99.99% w/w of the prepolymer component.

In another embodiment, other possible ranges of the isocyanate terminated intermediate compound would include, but are not limited to, from about 10% w/w to about 15% w/w, from about 16% w/w to about 20% w/w, from about 21% w/w to about 25% w/w, from about 26% w/w to about 30% w/w, from about 31% w/w to about 35% w/w, from about 36% w/w to about 40% w/w, from about 41% w/w to about 45% w/w, from about 46% w/w to about 50% w/w, from about 51% w/w to about 55% w/w, from about 56% w/w to about 60% w/w, from about 61% w/w to about 65% w/w, from about 66 Vow/w to about 70% w/w, from about 71% w/w to about 75% w/w, from about 76% w/w to about 80% w/w, from about 81% w/w to about 85% w/w, from about 86% w/w to about 90% w/w, from about 91% w/w to about 95% w/w, and from about 96% w/w to about 99.99% w/w of the prepolymer component.

According to another embodiment of the present disclosure, at least one polyol terminated intermediate compound is prepared from a reaction mixture comprising at least one isocyanate compound and at least one active hydrogen containing compound selected from the group consisting of a polyol compound, a polyamine compound and a combination thereof, wherein the polyol terminated intermediate compound is present in an amount from about 5% w/w to about 50% w/w of the curative component.

In another embodiment, other possible ranges of the polyol terminated intermediate compound would include, but are not limited to, from about 5% w/w to about 9% w/w, from about 10% w/w to about 15% w/w, from about 16% w/w to about 20% w/w, from about 21% w/w to about 25% w/w, from about 26% w/w to about 30% w/w, from about 31% w/w to about 35% w/w, from about 36% w/w to about 40% w/w, from about 41% w/w to about 45% w/w, from about 46% w/w to about 50% w/w of the curative component.

In one non-limiting embodiment, the polyol compound is selected from the group consisting of diols, triols, tetrols, pentols, and hexols.

In another non-limiting embodiment, the polyol is selected from the group consisting of polyether polyol, polyester polyol, polycarbonate polyol, ethylene oxide end-capped polyol, polybutadiene polyol, polyacetal polyol, and a combination thereof.

In one non-limiting embodiment, the polyol compound is present in an amount from about 5% w/w to about 80% w/w of the curative component.

In another embodiment, other possible ranges of the polyol compound would include, but are not limited to, from about 5% w/w to about 9% w/w, from about 10% w/w to about 15% w/w, from about 16% w/w to about 20% w/w, from about 21% w/w to about 25% w/w, from about 26% w/w to about 30% w/w, from about 31% w/w to about 35% w/w, from about 36% w/w to about 40% w/w, from about 41% w/w to about 45% w/w, from about 46% w/w to about 50% w/w, from about 51% w/w to about 55% w/w, from about 56% w/w to about 60% w/w, from about 61% w/w to about 65% w/w, from about 66% w/w to about 70% w/w, from about 71% w/w to about 75% w/w and from about 76% w/w to about 80% w/w of the curative component.

In one more non-limiting embodiment, the polyamine compound is selected from the group consisting of primary amine-terminated poly(oxypropylene), primary amine-terminated poly(oxyethylene), secondary amine-terminated poly(oxypropylene), secondary amine-terminated poly(oxyethylene) and amino functional polysiloxane.

In another non-limiting embodiment, the amine compound is selected from the group consisting of an aliphatic, a cycloaliphatic and an aromatic compound having about 2 to about 30 carbon atoms.

In another embodiment, the other possible ranges of the carbon atom(s) would include, but are not limited to, from about 2 to about 5, from about 6 to about 10, from about 11 to about 15, from about 16 to about 20, from about 21 to about 25, from about 26 to about 30.

In one more non-limiting embodiment, the amine compound is selected from the group consisting of ethylenediamine, 1,2-propylenediamine 1,3-propylenediamine, 1,2-butylenediamine, 1,3-butylenediamine, 1,4-butylenediamine, 2,3-butylenediamine, 1,2-cyclohexanediamine, 1,3-cyclohexanediamine, 1,4-cyclohexanediamine, hydrazine, pentamethylenediamine, hexamethylenediamine, heptamethylenediamine, octamethylenediamine, nonainethylenediamine, decamethylenediamine, undecamethylenediamine, dodecamethylenediamine, piperazine, N-(2-aminoethyl)piperazine, p-phenylenediamine, 4,4-methylenedianiline, N,N′-dimethylhexamethylenediamine and N,N-dibutylhexamethylenediamine.

The non limiting examples of amine compounds include, but are not limited to, aliphatic primary amines such as diethylenetriamine, ethylenediamine, tetramethylenediamine, pentamethylenediamine, hexamethylenediamine, aliphatic secondary amines such as N,N′-dibenzylethylenediamine, N,N-Bis[3-(methylamino)propyl]methylamine, Tris[2-(methylamino)ethyl] amine, N,N′-Di-tert-butylethylenediamine, N,N′,N″-Trihexyldiethylenetriamine, N,N′-Dimethyl-1,8-octanediamine, aromatic amines such as toluene diamines (particularly diethyltoluenediamine, dimethyltoluenediamine, dimethylthiotoluenediamine and 2,3-diaminotoluene), aniline derivates [(particularly 4,4′-methylenebis(N-sec-butylaniline)], naphthalene diamines (particularly 1,8-naphthalene diamine), benzene diamines (particularly diethylmethylbenzenediamine, N-benzylethylenediamine and N1,N4-Di(pentan-2-yl)benzene-1,4-diamine), mixtures between cycloaliphatic secondary and, primary aromatic amines such as 4-(2-aminoethyl)aniline, cycloaliphatic diamines and other sterically hindered diamines such as 1,8-Diamino-p-menthane, 1,3-cyclohexanedimethanamine, 4,4′-methylenebis(cyclohexylamine), 4,4′-Methylenebis(2-methylcyclohexylamine), isoprene diamine, bicyclo[2.2.1]heptanebis(methylamine), N-Phenylethylenediamine, aminocyclohexanol and derivates, piperazine and derivates such as 1-[2-(2-Hydroxyethoxy)ethyl]piperazine, 1-(2-Aminoethyl)piperazine, 2-(3-Methoxyphenyl)piperazine, and 1-(3-aminopropyl)piperazine.

According to one of the non-limiting embodiments, the isocyanate compound has the formula R(NCO)ₙ; wherein n=2, 3, and 4; and R=aliphatic moiety having 6 to 20 carbon atoms.

In another embodiment, other possible ranges of the number of carbon atoms would include, but are not limited to, from about 6 to about 10, from about 11 to about 15, and from about 16 to about 20.

The isocyanate is selected from the group consisting of an aromatic isocyanate and aliphatic isocyanate.

In one more non-limiting embodiment, the aromatic isocyanate is selected from the group consisting of diphenylmethane diisocyanates; polymethylene diphenyl diisocyanate; 4,4-methylene diphenyl isocyanate MIDI); p- and m-phenylene diisocyanate; 2,4- and 2,6-toluene diisocyanate (TDI); durene-1,4-diisocyanate; isophorone diisocyanate; isopropylene-bis-(p-phenyl isocyanate); sulfone-bis(p-phenyl isocyanate); 1,5-naphthalenediisocyanate; cumene-2,4-diisocyanate; 4-methoxy-1,3-phenylenediisocyanate; 4-chloro-1,3-phenylenediisocyanate; 4-bromo-1,3-phenylenediisocyanate; 4-ethoxy-1,3-phenylenediisocyanate; 2,4′-diisocyanatodiphenylether; 4,4′-diphenyldiisocyanate; 4,6-dimethyl-1,3-phenylenedsocyanate; 1,10-anthracenediisocyanate; 4,4′-diisocyanatodibenzyl; 3,3-dimethyl-4,4′-diisocyanatodiphenytmethane; 2,6-di-methyl-4,4′-diisocyanatodiphenyl; and a combination thereof.

In another non-limiting embodiment, the aliphatic isocyanate is selected from the group consisting of isophorone diisocyanate (IPDI); dicyclobexylmethane-4,4′-diisocyanate; hexamethylene-1,6-diisocyanate (HDI) including HDI trimer, HDI biuret, HDI uretidone, HDI allophanate; trimethyl hexamethylene diisocyanate (TMDI); pentamethylendiisocyanate (PDI); cyclohexylene diisocyanate, methylhexylene diisocyanate; hydrogenated TDI; hydrogenated MDI and a combination thereof.

According to one of the non-limiting embodiments, the isocyanate compound in the prepolymer component is present in an amount from about 0.01% w/w to about 90% w/w of prepolymer component.

In another embodiment, other possible ranges of the isocyanate compound would include, but are not limited to, from about 0.01% w/w to about 5% w/w, from about 6% yaw to about 10% w/w, from about 11% w/w to about 1.5% w/w, from about 16% w/w to about 20% w/w, from about 21% w/w to about 25% w/w, from about 26% w/w to about 30% w/w, from about 31% w/w to about 35% w/w, from about 36% w/w to about 40% w/w, from about 41% w/w to about 45% w/w, from about 46% w/w to about 50% w/w, from about 51% w/w to about 55% w/w, from about 56% w/w to about 60% w/w, from about 61 (Yow/w to about 65% w/w, from about 66% w/w to about 70% w/w, from about 71% w/w to about 75% w/w, from about 76% w/w to about 80% w/w, from about 81% w/w to about 85% w/w, and from about 86% w/w to about 90% w/w of the prepolymer component.

In another non-limiting embodiment, the liquid rubber is a hydrogenated or non-hydrogenated (co)polymer having a monomer moiety selected from the group consisting of isoprene, butadiene, styrene, ethylene, vinyl acetate, acrylonitrile, silicone and a combination thereof.

The liquid rubber can be selected from the group consisting of hydrogenated or non-hydrogenated forms of neoprene rubber, isoprene rubber, styrene butadiene rubber, ethylene vinyl acetate rubber, styrene-ethylene-butylene-styrene, butyl rubber, ethylene propylene diem monomer (EPDM), nitrite rubber and a combination thereof.

According to one of the non-limiting embodiments, the liquid rubber is present in amount from about 0% w/w to about 20% w/w of prepolymer component.

In another embodiment, other possible ranges of the liquid rubber would include, but are not limited to, from about 0% w/w to about 5% w/w, from about 6% w/w to about 10% w/w, from about 11% w/w to about 15% w/w, from about 16% w/w to about 20% w/w of the prepolymer component.

In another non-limiting embodiment, the liquid rubber is present in an amount from about 5% w/w to about 20% w/w of the curative component.

The liquid rubber preferably has a molecular weight of from about 2,000 to about 60,000 daltons, measured on a Hewlett-Packard 1050 Series HPLC system equipped with two GPC Ultrastyragel columns, 10³ and 10⁴ Å (5 μm mixed, 300 mm×19 mm, Waters Millipore Corporation, Milford, MA, USA) and THF as mobile phase.

In another embodiment, other possible ranges of molecular weight of the liquid rubber would include, but are not limited to, from about 2,000 to about 9,999, from about 10,000 to about 19,999, from about 20,000 to about 29,999, from about 30.000 to about 39,999, from about 40,000 to about 49,999, from about 50,000 to about 60,000 daltons.

In one more non-limiting embodiment, the catalyst is selected from the group consisting of tertiary amine catalysts, tin catalysts, organomercury catalysts, organozinc catalysts, organobismuth catalysts and a combination thereof.

The catalyst is present in an amount from about 0.01% w/w to about 5% w/w of the curative component.

In another embodiment, other possible ranges of the catalyst would include, but are not limited to, from about 0.01% w/w to about 1% w/w, from about 1.01% w/w to about 2% w/w, from about 2.01% w/w to about 3% w/w, from about 3.01% w/w to about 4% w/w, from about 4.01% w/w to about 5% w/w of the curative component.

In one non-limiting embodiment, the amine compound is in an amount from about 0% w/w to about 5% w/w of the curative component.

In another embodiment, other possible ranges of the amine compound would include, but are not limited to, from about 0% w/w to about 1% w/w, from about 1% w/w to about 2% w/w, from about 2% w/w to about 3% w/w, from about 3% w/w to about 4% w/w, and from about 4% w/w to about 5% w/w of the curative component.

In another non-limiting embodiment, the chain extender is a C₁₋₁₀ alkyl diol having a number average molecular weight of less than 200 daltons, measured on a Hewlett-Packard 1050 Series HPLC system equipped with two GPC Ultrastyragel columns, 10³ and 10⁴ Å (5 μm mixed, 300 mm×19 mm, Waters Millipore Corporation, Milford, MA, USA) and THF as mobile phase.

The chain extender preferably is selected from the group consisting of methyl-propanediol (MPD). 1,4-butanediol (BDO). 6-hexanediol (HDO), and a combination thereof.

The chain extender is present in an amount from about 0% w/w to about 10% w/w of the curative component.

In another embodiment, other possible ranges of the chain extender would include, but are not limited to, from about 0% w/w to about 1% w/w, from about 1% w/w to about 2% w/w, from about 2% w/w to about 3% w/w, from about 3% w/w to about 4% w/w, from about 4% w/w to about 5% w/w, from about 6% w/w to about 7% w/w, from about 7% w/w to about 8% w/w, from about 8% w/w to about 9% w/w, and from about 9% w/w to about 10% w/w of the curative component.

According to one of the non-limiting embodiments, the two-component polyurethane composition further comprises an additive selected from the group consisting of a filler, an antioxidant, an ultraviolet light inhibitor, a plasticizer, a thickening agent, a compatibilizer, dispersing agent, rheology modifier, and a molecular sieve.

According to one of the non-limiting embodiments, examples of filler generally include minerals (i.e., inorganic), typically in powder form, and which also serve to adjust the viscosity of the prepolymer component, including but not limited to, ground mica, talc, kaolin clay, organo-clay, calcium carbonate, calcium sulfite, colloidal silica, fumed silica, wollastonite, ballotini, hollow glass microspheres, glass, carbon and graphite fibers, metallic oxides (such as zinc, titanium, zirconium and the like), ground quartz, metallic silicates, metallic powders (such as lead, aluminium bronze, and the like).

The amount of filler present is generally selected to produce a viscosity so that the prepolymer component can be readily pumped through processing equipment such as adhesive meter-mixing machines. The possible ranges of the filler would include, but are not limited to, from about 10 to about 15 parts, from about 16 to about 20 parts, from about 21 to about 25 parts, from about 26 to about 30 parts, from about 31 to about 35 parts, from about 36 to about 40 parts, from about 41 to about 45 parts, from about 46 to about 50 parts, by weight per 100 parts by weight of the prepolymer compound or curative compound.

In another non-limiting embodiment, the composition is useful in adhesives, coatings, primers, paints and varnishes.

The two-component polyurethane composition and their applications according to the present disclosure may be prepared and used according to the examples set out below. These examples are presented herein for purposes of illustration of the present disclosure and are not intended to be limiting, for example, the preparations of the compositions and their applications.

### EXAMPLES

### Example 1: Two Component Polyurethane Composition

A prepolymer part and curative component were prepared from the ingredients shown in Table 1.

The prepolymer component was prepared by introducing the Isocyanate (683 g) into a mixing vessel at room temperature and heating to 75-85° C. for 1 hour. Talc filler (124 g) was added to the mixture and mixed in for 5 minutes at 80° C., followed by addition of the organo-clay (61 g) and Hydrophobic fumed silica (27 g) mixing for 15 minutes at 80° C. The mixture was cooled to 65° C. and the molecular sieve (105 g) mixed in for 30 minutes at 65° C.

The curative component was prepared by introducing polyol (1) (464 g), polyol (2) (234 g), the additive (8.1 g) and the plasticizer (113 g) into a mixing vessel and heating to 88-93° C. for 1 hour under vacuum. The filler (1) (53 g) and the filler (2) (81 g) were added and mixed for 15 minutes. After cooling to 85° C., half of the amount of the molecular sieves (10.2 g) was added and dispersed under vacuum for 15 minutes. The resulting mixture was cooled to 65° C. and the amine (22.1 g) was added and mixed for 15 minutes, followed by addition and mixing under vacuum of the second half of the molecular sieves (10.2 g), catalyst (2.3 g) and pigment (2.12) for 30 minutes. It should be noted that the mixing performance was adequate to disperse the plasticizer.

TABLE 1
Composition of Prepolymer Part and Curative Part

| | |
|---|---|
| Brief chemical description | Percentage % |

Prepolymer Part (A)

| | |
|---|---|
| Prepolymerised diphenylmethane diisocyanate (MDI) | 68.3 |
| Talc | 12.4 |
| Filler: Organomodified clay | 6.1 |
| Hydrophobic fumed silica | 2.7 |
| Molecular sieve powder | 10.5 |
| | 100.00 |

Curative Part (B)

| | |
|---|---|
| Branched co-polyester triol derived from caprolactone | 46.4 |
| monomer, terminated by hydroxyl groups | |
| Low molecular weight polyester triol terminated by | 23.4 |
| primary hydroxyl groups | |
| Filler: Organomodified clay | 5.3 |
| Liquid Rubber | 11.3 |
| Filler: Talc | 8.1 |
| Hyperbranched wetting and dispersing additive | 0.81 |
| Norbornane diamine | 2.21 |
| Molecular sieve powder | 2.04 |
| Carbon black pigment | 0.21 |
| Solution of triethylenediamine and dipropylene glycol | 0.23 |
| | 100.00 |

### Example 2: Two-Component Polyurethane Composition

A prepolymer component was prepared from the ingredients
shown in Table 1 according to the method described in
Prepolymer Part (A) of Example 1. A curative component
was prepared from the ingredients shown in Table 2. Table
2: Composition of Curative PartCurative part

| Brief chemical description | Percentage % |
|---|---|
| Branched co-polyester triol derived from caprolactone | 27.58 |
| monomer, terminated by hydroxyl groups | |
| Low molecular weight polyester triol terminated by | 38.6 |
| primary hydroxyl groups | |
| Filler: organomodified clay | 5.69 |
| Liquid Rubber | 12.00 |
| Filler: Talc | 8.61 |
| Solution of triethylenediamine and dipropylene glycol | 0.23 |
| (Catalyst) | |
| Norbornane diamine | 2.77 |
| Molecular sieve powder | 3.42 |
| Pigment | 1.1 |
| | 100.00 |

### Example 3: Two-Component Polyurethane Composition

TABLE 3
Composition of Prepolymer

| Prepolymer Component | % wt |
|---|---|
| Polypropylene glycol | 30.0 |
| Mix of polymethylene polyphenyl isocyanate (60%) and | 52.5 |
| 4,4′-diphenylmethane diisocyanate (30%) | |
| Talc | 5.3 |
| Fumed silica | 0.7 |
| Organo-modified Sepiolite (<15% of quaternary | 1.6 |
| ammonium compounds) | |
| Molecular sieve poder | 9.9 |
| Total | 100 |

A prepolymer component was prepared from the ingredients shown in Table 3.

The prepolymer component was prepared by introducing the polyol (720 g) into a mixing vessel at room temperature and heating to 75-85° C. for 1 hour. A first portion of the isocyanate (712.82) was added and mixed for 30 minutes at 75° C. Talc filler (144 g) was added to the mixture and mixed in for 5 minutes at 80° C., followed by addition of the organo-clay (38.4 g) and mixing for 15 minutes at 80° C. The mixture was cooled to 65° C. and the molecular sieve (237.6 g) mixed in for 30 minutes at 65° C. The remaining portion of the isocyanate (547.2 g) was added to the mixture, and mixed in for 30 minutes at 65° C.

A curative component was prepared from the ingredients shown in Table 4.

TABLE 4
Composition of Curative Part

| Curative Component | % wt |
|---|---|
| EO Capped PO triol | 36.0 |
| Tetrafunctional alkoxylated polyol | 13.0 |
| 1,3-methyl-2-propanediol | 5.3 |
| Halogenated polyetherpolyol | 9.8 |
| Liquid Rubber | 10.90 |
| Organo-modified Sepiolite (<15% of quaternary | 0.9 |
| ammonium compounds) | |
| Rheology additive type | 2.52 |
| Adhesion promoter additive | 2.0 |
| untreated fumed silica | 1.5 |
| Norbornane diamine | 2.2 |
| Talc (Mistron ® 20G) | 9.8 |
| Zeolite 3A molecular sieve poder | 5.1 |
| Tin catalyst | 0.013 |
| Amine catalyst type POLYCAT 77 | 0.09 |
| Amine catalyst type POLYCAT SA20 | 0.13 |
| Amine catalyst type POLYCAT SA8 | 0.17 |
| Carbon black pigment type | 0.577 |
| Total | 100 |

The curative component was prepared by introducing polyol (1) (864.0 g), polyol (2) (312.0 g), polyol (3) (127.2 g), polyol (4) (325.20 g), plasticizer (261.60 g), filler (1) (21.60 g) and filler (2) (36 g) into a mixing vessel and heating to 88-93° C. for 1 hour under vacuum. At same temperature, filler (3) (235.20 g) was added and mixed for 1 hour under vacuum. After cooling down to 80° C., a third of the molecular sieves amount was charged (40.8 g) into the mixing vessel and mixed for 30 minutes under vacuum. The additive (1) (60.48 g) was added and mixed under vacuum for 40 minutes. The second third part of the molecular sieves was charged (40.8 g) and mixed under vacuum for 30 minutes. After cooling down to 70° C., the amine was then charged (52.80 g) and mixed under vacuum for 15 minutes. The last third part of molecular sieves was charged (40.82) and mixed under vacuum for 30 minutes. The mixture was cooled to 60° C. followed by the addition of the color pigment (13.85 g), the additive (2) (48.00 g), the catalyst (I) (0.31 g), catalyst (2) (2.16 g), catalyst (3) (3.128) and catalyst (4) (0.17 g) followed by a final mixing under vacuum for 30 minutes. It should be noted that the mixing performance was adequate to disperse properly the plasticizer to obtain the desired result.

### Example 4: Two-Component Polyurethane Composition

A prepolymer component was prepared from the ingredients shown in Table 3 of Example 3.

The curative component was prepared according to Table 5 introducing polyol (1) (864.0 g), polyol (2) (432.0 g), polyol (3) (192.0 g), plasticizer (288.0 g), filler (1) (36.0 g) and filler (2) (34.08 g) into a mixing vessel and heating to 88-93° C. for 1 hour under vacuum. At same temperature, filler (3) (240.17 g) was added and mixed for 1 hour under vacuum. After cooling down to 80° C., a third of the molecular sieves amount was charged (43.2 g) into the mixing vessel and mixed for 30 minutes under vacuum. The additive (1) (59.28 g) was added and mixed under vacuum for 40 minutes. The second third part of the molecular sieves was charged (43.2 g) and mixed under vacuum for 30 minutes. After cooling down to 70° C., the amine was then charged (52.80 g) and mixed under vacuum for 15 minutes. The last third part of molecular sieves was charged (43.2 g) and mixed under vacuum for 30 minutes. The mixture was cooled to 60° C. followed by the addition of the color pigment (14.4 g), the additive (2) (48.00 g), the catalyst (I) (0.31 g), catalyst (2) (2.16 g), catalyst (3) (3.12 g) and catalyst (4) (0.17 g) followed by a final mixing under vacuum for 30 minutes. It should be noted that the mixing performance was adequate to disperse properly the plasticizer to obtain the desired result.

TABLE 5
Composition of Curative Part

| Curative Component | % wt |
|---|---|
| EO Capped PO triol | 36.0 |
| Tetrafunctional alkoxylated polyol | 18.0 |
| 1,3-methyl-2-propanediol | 8.0 |
| Liquid Rubber | 10.90 |
| Organo-modified Sepiolite (<15% of quaternary ammonium | 1.42 |
| compounds) (Pangel ® B20) | |
| Rheology additive type BYK 2720 | 2.47 |
| Adhesion promoter additive | 2.0 |
| Untreated fumed silica | 1.5 |
| 4,4-Diaminodicyclohexylmethane | 2.2 |
| Talc | 10.01 |
| Molecular sieve poder | 5.4 |
| Tin catalyst type | 0.013 |
| Amine catalyst type POLYCAT 77 | 0.09 |
| Amine catalyst type POLYCAT SA20 | 0.13 |
| Amine catalyst type POLYCAT SA8 | 0.17 |
| Carbon black pigment type | 0.6 |

While this invention has been described in detail with reference to certain preferred embodiments, it should be appreciated that the present disclosure is not limited to those precise embodiments. Rather, in view of the present disclosure, many modifications and variations would present themselves to those skilled in the art without departing from the scope and spirit of this invention.

1. A two-component polyurethane composition comprising:
(A) a prepolymer component comprising:
(i) at least one isocyanate terminated intermediate compound prepared from a reaction mixture comprising at least one isocyanate compound and at least one active hydrogen containing compound selected from the group consisting of a polyol compound, a polyamine compound and a combination thereof,
(ii) at least one isocyanate compound, and
(iii) optionally at least one liquid rubber; and
(B) a curative component comprising:
(i) at least one polyol terminated intermediate compound prepared from a reaction mixture comprising at least one isocyanate compound and at least one active hydrogen containing compound selected from the group consisting of a polyol compound, a polyamine compound and a combination thereof,
(ii) at least one liquid rubber,
(iii) at least one catalyst,
(iv) at least one polyol,
(v) optionally at least one amine compound, and
(vi) optionally a chain extender.

2. The two-component polyurethane composition according to claim 1, wherein the ratio of prepolymer component to curative component is from about 0.1 to about 1.

3. The two-component polyurethane composition according to claim 1, 1(A)(1), wherein the reaction mixture (A)(i) has a ratio of isocyanate compound to polyol compound greater than 4.

4. The two-component polyurethane composition according to claim 1, wherein the reaction mixture (B)(i) has a ratio of isocyanate compound to polyol compound less than 2.

5. The two-component polyurethane composition according to claim 1, wherein the isocyanate terminated intermediate compound is present in an amount from about 10% w/w to about 99.99% w/w of said prepolymer component.

6. The two-component polyurethane composition according to claim 1, wherein the polyol terminated intermediate compound present in an amount from about 5% w/w to about 50% w/w of said curative component.

7. The two-component polyurethane composition according to claim 1, wherein the polyol compound is selected from the group consisting of diols, triols, tetrols, pentols, and hexols.

8. (canceled)

9. The two-component polyurethane composition according to claim 1, wherein the polyol compound is present in an amount from about 5% w/w to about 80% w/w of said curative component.

10. The two-component polyurethane composition according to claim 1, wherein said polyamine compound is selected from the group consisting of primary amine-terminated poly(oxypropylene), primary amine-terminated poly (oxyethylene), secondary amine-terminated poly(oxypropylene), secondary amine-terminated poly(oxyethylene) and amino functional polysiloxane.

11. The two-component polyurethane composition according to claim 1, wherein the amine compound is selected from the group consisting of an aliphatic, cycloaliphatic and an aromatic compound having about 2 to about 30 carbon atoms.

12. (canceled)

13. The two-component polyurethane composition according to claim 1, wherein the isocyanate compound has the formula R(NCO)ₙ; wherein n=2, 3, and 4; and R=aliphatic moiety having from 6 to 20 carbon atoms.

14. (canceled)

15. (canceled)

16. (canceled)

17. The two-component polyurethane composition according to claim 1, wherein the isocyanate compound is present in an amount from about 0.01% w/w to about 90% w/w of said prepolymer component.

18. The two-component polyurethane composition according to claim 1, wherein the liquid rubber is a hydrogenated or non-hydrogenated (co)polymer having a monomer moiety selected from the group consisting of isoprene, butadiene, styrene, ethylene, vinyl acetate, acrylonitrile, silicone and a combination thereof.

19. (canceled)

20. The two-component polyurethane composition according to claim 1, wherein the liquid rubbers-present in an amount from more than 0% w/w to about 20% w/w of said prepolymer component.

21. The two-component polyurethane composition according to claim 1, wherein the liquid rubber present in an amount from about 5% w/w to about 20% w/w of curative component.

22. (canceled)

23. The two-component polyurethane composition according to claim 1, wherein the catalyst is selected from the group consisting of tertiary amine catalysts, tin catalysts, organomercury catalysts, organozinc catalysts, organobismuth catalysts and a combination thereof.

24. (canceled)

25. The two-component polyurethane composition according to claim 1, wherein the amine compound is present in an amount from about 0% w/w to about 5% w/w of said curative component.

26. The two-component polyurethane composition according to claim 1, wherein the chain extender is a C₁₋₁₀ alkyl diol.

27. The two-component polyurethane composition according to claim 1, wherein the chain extender is selected from the group consisting of methyl-propanediol (MPD), 1,4-butanediol (BDO), 1,6-hexanediol (HDO), and a combination thereof.

28. (canceled)

29. The two-component polyurethane composition according to claim 1, further comprising an additive selected from the group consisting of a filler, an antioxidant, an ultraviolet light inhibitor, a plasticizer, a thickening agent, a compatibilizer, a dispersing agent, a rheology modifier, and a molecular sieve.

30. (canceled)
